(19) United States
(12) Patent Application Publication
(10) Pub. No.: US 2016/0054341 A1
(43) Pub. Date: Feb. 25, 2016

(54) SAMPLE CONTAINER CARRIER FOR A LABORATORY SAMPLE DISTRIBUTION SYSTEM, LABORATORY SAMPLE DISTRIBUTION SYSTEM AND LABORATORY AUTOMATION SYSTEM

(71) Applicant: Roche Diagnostics Operations, Inc., Indianapolis, IN (US)

(72) Inventor: Matthias Edelmann, Stuttgart (DE)

(21) Appl. No.: 14/825,522

(22) Filed: Aug. 13, 2015

(30) Foreign Application Priority Data
Aug. 21, 2014 (EP) 14181782.5

(51) Int. Cl. G01N 35/00; B65G 54/02

(52) U.S. Cl. CPC G01N 35/00584; B65G 54/02

(57) ABSTRACT

A sample container carrier, a laboratory sample distribution system comprising such a sample container carrier, and to a laboratory automation system comprising such a laboratory sample distribution system are presented. The sample container carrier can tilt a sample container in order to allow higher acceleration rates.

### CROSS-REFERENCE TO RELATED APPLICATIONS

This application claims priority to EP 14181782.5, filed Aug. 21, 2014, which is hereby incorporated by reference.

### BACKGROUND

The present disclosure generally relates to a sample container carrier for a laboratory sample distribution system and, in particular, to a laboratory sample distribution system containing such a sample container carrier, and to a laboratory automation system containing such a laboratory sample distribution system.

A sample container carrier for a laboratory sample distribution system is typically adapted to move on a transport plane of the laboratory sample distribution system. It comprises a holder for a sample container to support the sample container.

Sample containers are typically made of transparent plastic material or glass material and usually have the form of a tube having an opening at the top side. Such sample containers can be used in order to hold medical samples such as blood samples.

A laboratory sample distribution system comprising such sample container carriers can be used in order to transport sample containers between laboratory stations. Such laboratory stations can be used in order to analyze the samples contained in the sample containers and can, for example, be incorporated as pre-analytical, analytical and/or post-analytical stations. A laboratory sample distribution system significantly increases sample throughput through a laboratory automation system comprising such laboratory stations and can provide for a secure autonomous operation of the laboratory automation system.

Throughput of such a laboratory sample distribution system is related to a maximum speed that the sample container carriers can achieved on the transport plane and with maximum acceleration and deceleration of the sample container carriers in order to obtain an operating speed or to slow down. However, high acceleration values can lead to spilling over of a sample contained in a sample container, or to tipping over of the complete sample container together with the contained sample. This can lead to significant delays in operation and to contamination of the transport plane which can harm the reliability of measurements performed by the laboratory stations.

Therefore, there is a need for a sample container carrier for a laboratory sample distribution system that allows for higher acceleration and deceleration values.

### SUMMARY

According to the present disclosure, A sample container carrier for a laboratory sample distribution system, a laboratory sample distribution system, and a laboratory automation system are presented. The sample container carrier can move on a transport plane of the laboratory sample distribution system. The sample container carrier can comprise a holder for a sample container adapted to hold the sample container. The holder can comprise an acceleration compensator adapted to tilt the sample container held by the holder in a direction of acceleration of the sample container carrier.

Accordingly, it is a feature of the embodiments of the present disclosure to provide for a sample container carrier for a laboratory sample distribution system that allows for higher acceleration and deceleration values. Other features of the embodiments of the present disclosure will be apparent in light of the description of the disclosure embodied herein.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 illustrates a sample container carrier according to an embodiment of the present disclosure.

FIG. 2 illustrates a part of a sample container carrier holding a tilted sample container according to an embodiment of the present disclosure.

FIG. 3 illustrates a laboratory automation system according to an embodiment of the present disclosure.

### DETAILED DESCRIPTION

In the following detailed description of the embodiments, reference is made to the accompanying drawings that form a part hereof, and in which are shown by way of illustration, and not by way of limitation, specific embodiments in which the disclosure may be practiced. It is to be understood that other embodiments may be utilized and that logical, mechanical and electrical changes may be made without departing from the spirit and scope of the present disclosure.

The present disclosure relates to a sample container carrier for a laboratory sample distribution system. The sample container carrier can move on a transport plane of the laboratory sample distribution system. The sample container carrier can comprise a holder for a sample container to support, hold and/or fix the sample container.

The holder can comprise an acceleration compensator. The acceleration compensator can tilt or rotate the sample container comprised in the holder in a direction of acceleration of the sample container carrier.

With the sample container carrier, it can be possible to tilt or rotate the sample container such that spilling over of a contained sample can be less likely or prevented. This can be due to the fact that the tilting of the sample container comprised in the holder in a direction of acceleration of the sample container carrier can resemble typical behavior of a sample contained in the sample container during acceleration. In other words, the sample container can be tilted such that spilling of the sample can be reduced or prevented.

It can be noted that deceleration can be treated as a negative acceleration. The principles disclosed herein can be equally applicable for positive acceleration and for negative acceleration.

It can be further be noted that the word “tilting” can be understood so that it can relate to the top portion of a sample container. For example, if the sample container carrier accelerates positively in a certain direction, the top portion of the sample container, for example, an opening of the sample container, can be tilted such that this top portion can be moved further in this direction with respect to the sample container carrier.

According to an embodiment, the acceleration compensator can tilt the sample container comprised in the holder in the direction of acceleration of the sample container carrier such that an upper part of the sample container can be tilted in the direction of acceleration.

According to an embodiment, the acceleration compensator can comprise an inertia element. Such an inertia element can, for example, be implemented as a massive element engineered out of a metal or another substance having a relatively high specific weight. The inertia element can sense acceleration, for example, by its relative movement to the rest of the sample container carrier. It can be used in order to control tilting of the sample container carrier.

According to an embodiment, the inertia element can be made of a material having a higher density than other or remaining materials of the sample container carrier. This can provide an effective sensing of the acceleration of the sample container carrier.

According to an embodiment, the inertia element can accelerate delayed in time with respect to the rest of the sample container carrier. The inertia element may cause the sample container comprised in the holder to be tilted in the direction of acceleration of the sample container carrier. Such an embodiment can provide for an effective tilting of the sample container without the need for active or electronic components.

According to an embodiment, the inertia element can comprise a recess to support the sample container. This can allow for a direct support of the sample container by the inertia element and for a simple embodiment having only a few movable parts.

According to an embodiment, the holder can comprise an elastomeric material at least partially radially surrounding the inertia element. This can allow for a damped movement of the inertia element relative to the rest of the sample container carrier, for example, relative to a plane on which the inertia element can move. If the sample container carrier accelerates, the inertia element can move relative to the rest of the sample container carrier while deforming the elastomeric material and thus can automatically tilts the sample container.

It can be noted that embodiments in which a sample container is directly comprised in, or supported by the inertia element, can be embodied such that the sample container can be laterally supported by a lateral support above the inertia element. Such lateral support can, for example, be implemented such that it can laterally support the sample container at a position in the upper half of the sample container. When the inertia element as described and the lateral support interact, they can provide for a tilting of the sample container as intended.

According to an embodiment, the holder can comprise a supporting element having a recess to support the sample container. The supporting element may be swivel-mounted in the sample container carrier and the inertia element can be located below the supporting element and fixedly connected with the supporting element. This embodiment can be regarded as an alternative to embodiments in which the sample container is directly held by in the inertia element. It can provide also for an effective embodiment of tilting the sample container.

A laboratory sample distribution system is also presented. The laboratory sample distribution system can comprises a plurality of sample container carriers. Each sample container carrier may additionally comprise a magnetically active device, e.g., in the form of a permanent magnet.

The laboratory sample distribution system can further comprise a transport plane to support the sample container carriers. It can also comprise a plurality of electro-magnetic actuators stationary arranged below the transport plane. The electro-magnetic actuators can move respective sample container carriers on top of the transport plane by applying a magnetic force to the sample container carriers.

The laboratory sample distribution system can further comprise a control device to control the movement of the sample container carriers on top of the transport plane by driving the electro-magnetic actuators such that the sample container carriers can move along corresponding transport paths.

By the use of the laboratory sample distribution system, the advantages discussed above with respect to the sample container carriers can be used for a laboratory sample distribution system. Especially, use of the sample container carriers can allow for a faster operation of the laboratory sample distribution system because higher acceleration values can be achieved.

The laboratory sample distribution system can comprise a plurality of sample container carriers and a transport plane to support the sample container carriers. The laboratory sample distribution system can be embodied such that each sample container carrier can further comprise a driver to self-propel the sample container carrier for movement on the transport plane, independent from the driver comprised under the transport plane. The laboratory sample distribution system can further comprises a control device to control the movement of the sample container carriers on top of the transport plane by instructing the driver so that the sample container carriers move along corresponding transport paths.

By this embodiment, the sample container carrier can be used for a laboratory sample distribution system in which sample container carriers can be implemented such that they drive autonomously.

A laboratory automation system is also presented. The laboratory automation system can comprise a plurality of pre-analytical, analytical and/or post-analytical (laboratory) stations, and a laboratory sample distribution system according to one of the embodiments as described above to distribute the sample container carriers and/or sample containers between the stations. The stations may be arranged adjacent to the laboratory sample distribution system.

Pre-analytical stations may perform any kind of pre-processing of samples, sample containers and/or sample container carriers. Analytical stations may use a sample or part of the sample and a reagent to generate a measuring signal. The measuring signal can indicate if and in which concentration, if any, an analyte exists. Post-analytical stations may perform any kind of post-processing of samples, sample containers and/or sample container carriers.

The pre-analytical, analytical and/or post-analytical stations may comprise at least one of a decapping station, a recapping station, an aliquot station, a centrifugation station, an archiving station, a pipetting station, a sorting station, a tube type identification station, a sample quality determining station, an add-on buffer station, a liquid level detection station, and a sealing/desealing station.

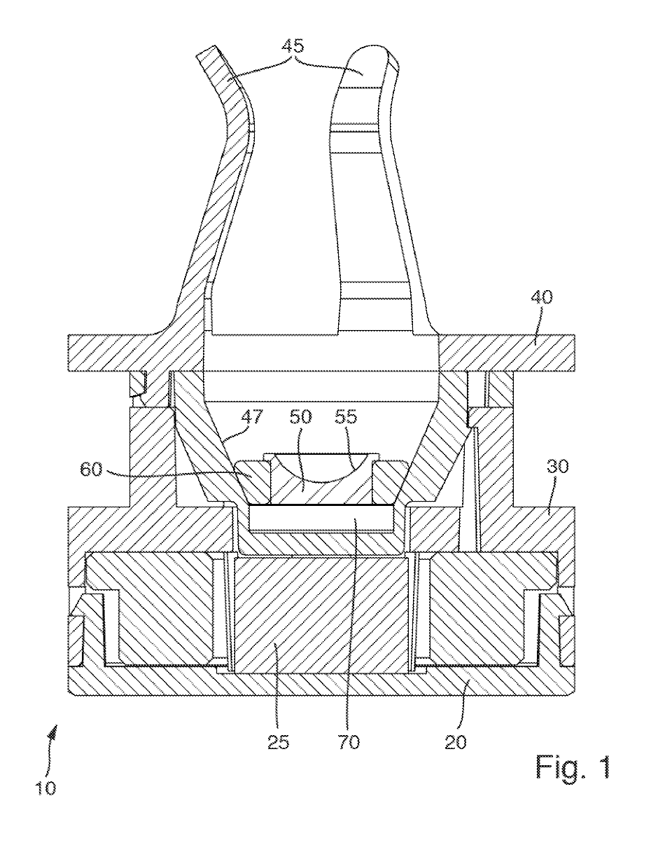

Referring initially to FIG. 1, FIG. 1 shows an embodiment of a sample container carrier 10. The sample container carrier 10 can comprise a bottom plate 20 on which the sample container carrier 10 can slide over a transport plane of a laboratory sample distribution system. Above the bottom plate 20, a magnetically active element in the form of a permanent magnet 25 can be arranged. Above the permanent magnet 25, a middle element 30 of the sample container carrier 10 can be arranged.

Above the middle element 30, a top element 40 can be arranged. The top element 40 can comprise three springs 45, wherein only two of the three springs 45 are depicted in FIG. 1. The springs 45 can laterally engage a sample container such that it can be held in the sample container carrier 10, but can still be tilted.

The top element 40 can further comprise a cone-shaped recess 47. The cone-shaped recess 47 can be arranged below the springs 45 and can comprise a plate-shaped element 70 at its lower portion. The plate-shaped element 70 can have an upper surface.

In the recess 47, which may be cone-shaped, rotation-symmetric, or the like, an inertia element 50 can be arranged. The inertia element 50 can comprises a recess 55 to support a sample container. The inertia element 50 can be arranged inside a resilient member 60 made of elastomeric material. The inertia element 50 can be supported on the surface provided by the plate-shaped element 70 and can move horizontally on this surface. The springs 45, the inertia element 50 and the resilient member 60 can comprise the holder. The holder can hold a corresponding sample container.

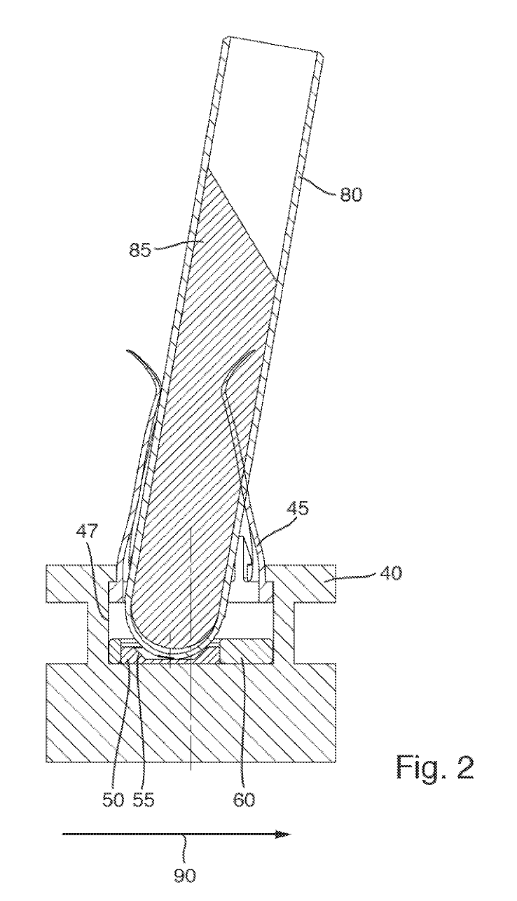

When a sample container is comprised in the sample container carrier 10, it can be held at its lower portion by the recess 55 of the inertia element 50 and can be held at its upper portion by the springs 45. When the sample container carrier 10 accelerates, the inertia element 50 can move in a direction opposite to the direction of acceleration relative to the remaining parts of the sample container carrier 10 due to the inertia force against a force generated by the resilient member 60, thus tilting the sample container. The inertia element 50 and the resilient member 60 can thus be regarded as acceleration compensator. The underlying principle can be the same as explained in the following with respect to FIG. 2.

FIG. 2 shows an alternative embodiment of an upper element 40. The upper element 40 can be part of a sample container carrier, wherein other parts of the sample container carrier are not shown except for the parts described in the following.

The upper element 40 can comprise three springs 45, two of which are shown in FIG. 2. The springs 45 can laterally support a sample container 80 contained in the sample container carrier.

The upper element 40 can comprises a recess 47, which can be cylindrically shaped. In the recess 47, an inertia element 50 can be arranged having a recess 55 surrounded by a resilient member 60. The functionality of the inertia element 50 and the resilient member 60 can be identical to the functionality as described with respect to FIG. 1.

A tube-shaped sample container 80 can be contained in the sample container carrier shown in FIG. 2. With its lower end, the sample container 80 can be contained in the recess 55 of the inertia element 50. At its upper portion, the sample container 80 can be laterally supported by the springs 45. When the sample container carrier accelerates in a direction shown with an arrow 90, the inertia element 50 can move opposite to this direction 90 with respect to the remaining parts of the sample container carrier. This can lead to a tilting of the sample container 80.

A sample 85 can be contained in the sample container 80. The sample 85 can have an inclined surface which can be caused by the acceleration along the direction 90. As shown, a distance between the sample 85 and the upper end of the sample container 80 can be larger at the top of the inclined surface than it can be if the sample container 80 was not tilted. Thus, the sample container carrier can provide for a reduced likelihood of spilling of the sample 85 and can allow for higher acceleration values.

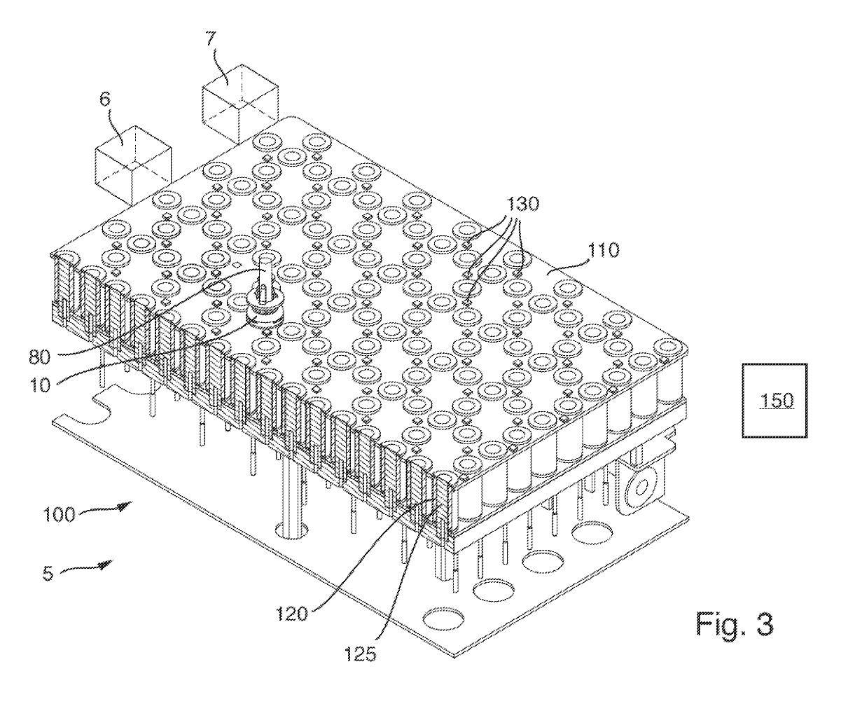

FIG. 3 shows a laboratory automation system 5. The laboratory automation system 5 can comprise a laboratory sample distribution system 100. It can further comprise a first laboratory station 6 and a second laboratory station 7. The laboratory stations 6, 7 can be used in order to analyze samples contained in sample containers 80.

The laboratory sample distribution system 100 can comprise a transport plane 110, under which a plurality of electro-magnetic actuators 120 in the form of magnetic coils can be arranged. Each electro-magnetic actuator 120 can have a ferromagnetic core 125. A plurality of Hall-sensors 130 can be distributed over the transport plane 110. On the transport plane 110, a sample container carrier 10 according to FIG. 1 can be positioned. The sample container carrier 10 can carry a sample container 80. It can be understood that the sample container carrier 10 is only shown as an example, and that typically a laboratory sample distribution system 100 can comprise a plurality of sample container carriers 10.

The laboratory sample distribution system 100 can further comprise a control unit 150 to control the electro-magnetic actuators 120 such that the sample container carrier 10 can move over the transport plane 110 by electro-magnetic force. The control unit 150 can apply an acceleration to the sample container carrier 10 that can be higher compared with usage of conventional sample container carriers because the sample container carrier 10 has the tilting functionality described above.

It is noted that terms like “preferably,” “commonly,” and “typically” are not utilized herein to limit the scope of the claimed embodiments or to imply that certain features are critical, essential, or even important to the structure or function of the claimed embodiments. Rather, these terms are merely intended to highlight alternative or additional features that may or may not be utilized in a particular embodiment of the present disclosure.

Having described the present disclosure in detail and by reference to specific embodiments thereof, it will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these preferred aspects of the disclosure.

We claim:

1. A sample container carrier for a laboratory sample distribution system, wherein the sample container carrier moves on a transport plane of the laboratory sample distribution system, the sample container carrier comprising:
a holder for a sample container adapted to hold the sample container, the holder comprises,
an acceleration compensator adapted to tilt the sample container held by the holder in a direction of acceleration of the sample container carrier.

2. The sample container carrier according to claim 1, wherein the acceleration compensator is adapted to tilt the sample container held by the holder in the direction of acceleration of the sample container carrier such that an upper part of the sample container is tilted in the direction of acceleration.

3. The sample container carrier according to claim 1, wherein the acceleration compensator comprises an inertia element.

4. The sample container carrier according to claim 3, wherein the inertia element is made of a material having a higher density than other materials of the sample container carrier.

5. The sample container carrier according to claim 3, wherein the inertia element comprises a recess adapted to support the sample container.

6. The sample container carrier according to claim 3, wherein the holder comprise an elastomeric material at least partially radially surrounding the inertia element.

7. The sample container carrier according to claim 6, wherein the elastomeric material is formed as an elastomeric ring surrounding the inertia element.

8. The sample container carrier according to claim 3, wherein the holder comprises a supporting element having a recess to support the sample container, wherein the supporting element is swivel-mounted in the sample container carrier, and wherein the inertia element is located below the supporting element and fixedly connected to the supporting element.

9. A laboratory sample distribution system, the laboratory sample distribution system comprising:
a plurality of sample container carriers according to claim 1, wherein each sample container carrier comprises a magnetically active device;
a transport plane adapted to support the sample container carriers;
a plurality of electro-magnetic actuators stationary arranged below the transport plane, wherein the electro-magnetic actuators are adapted to move respective sample container carriers on top of the transport plane by applying a magnetic force to the sample container carriers; and
a control device to control the movement of the sample container carriers on top of the transport plane by driving the electro-magnetic actuators such that the sample container carriers move along corresponding transport paths.

10. A laboratory sample distribution system, the laboratory sample distribution system comprising:
a plurality of sample container carriers according to claim 1;
a transport plane adapted to support the sample container carriers, wherein each sample container carrier further comprises a driver adapted to propel the sample container carrier for movement on the transport plane; and
a control device configured to control the movement of the sample container carriers on top of the transport plane by controlling the driver such that the sample container carriers move along corresponding transport paths.

11. A laboratory automation system, the laboratory automation system comprising:
a plurality of laboratory stations; and
a laboratory sample distribution system according to claim 9 adapted to distribute sample container carriers and/or sample containers between the laboratory stations.

12. The laboratory automation system according to claim 11, wherein the plurality if laboratory systems are pre-analytical, analytical and/or a post-analytical stations.
